(19) United States
(12) Patent Application Publication
(10) Pub. No.: US 2019/0015969 A1
(43) Pub. Date: Jan. 17, 2019

(54) LOCATING POSITIONS ON COMPONENTS

(71) Applicant: Sikorsky Aircraft Corporation, Stratford, CT (US)

(72) Inventor: Nathan Doane, Shelton, CT (US)

(73) Assignees: Sikorsky Aircraft Corporation, Stratford, CT (US); Sikorsky Aircraft Corporation, Stratford, CT (US)

(21) Appl. No.: 15/748,737

(22) PCT Filed: Jul. 25, 2016
(86) PCT No.: PCT/US2016/043848

§ 371 Date: Jan. 30, 2018

Related U.S. Application Data
(60) Provisional application No. 62/199,005, filed on Jul. 30, 2015.

(51) Int. Cl. B25H 7/04; B25H 7/02

(52) U.S. Cl. CPC B25H 7/045; G01B 3/14; B25H 7/02

(57) ABSTRACT

A method of locating position on a component includes engaging a template with a component and marking a location on the component using marking features of the template. Marking a location can include marking a plurality of locations on the component using a plurality of respective marking features of the template. Each marking feature of the template can include a corner formed where at least two edges meet on the template. Marking each respective location on the component can include marking two line segments that cross at an intersection point, wherein the two line segments follow the edges of the template at each respective corner, to mark the respective location on the component at the intersection of the two respective line segments. For example, marking each location can include marking a center point location for a strain gage, as well as the horizontal and vertical orientation.

### CROSS-REFERENCE TO RELATED APPLICATIONS

The subject application claims the benefit of priority from U.S. Provisional Application No. 62/199,005, filed Jul. 30, 2015, the entire disclosure of which is incorporated herein by reference in its entirety.

### BACKGROUND OF THE INVENTION

### 1. Field of the Invention

The present disclosure relates to locating positions on components, for example for proper placement of strain gages on test specimens for aerospace components.

### 2. Description of Related Art

Proper placement of gages for monitoring mechanical components presents challenges. For example, installing a strain gage on a mechanical component that has a complex geometry can present challenges. For example, it can be difficult to determine the proper location for the strain gage, as tolerances for strain gage position can be as narrow. In a manufacturing setting where multiple specimens of a component need strain gages, repeatability of strain gage placement is difficult. Reasons for these difficulties include lack of convenient hard points from which to measure location, difficulties in interpreting complicated drawing views and dimensions, and geometries that limit visibility and/or access for measurement devices. As a result, traditional techniques for placement of gages involve relatively labor intensive processes.

Such conventional methods and systems have generally been considered satisfactory for their intended purpose. However, there is still a need in the art for improved location. The present disclosure provides a solution for this need.

### SUMMARY OF THE INVENTION

A method of locating position on a component includes engaging a template with a component and marking a location on the component using marking features of the template.

Marking a location can include marking a plurality of locations on the component using a plurality of respective marking features of the template. Each marking feature of the template can include a corner formed where at least two edges meet on the template. Marking each respective location on the component can include marking two line segments that cross at an intersection point, wherein the two line segments follow the edges of the template at each respective corner, to mark the respective location on the component at the intersection of the two respective line segments. For example, marking each location can include marking a center point location for a strain gage, as well as the horizontal and vertical orientation.

Engaging the template with the component can include engaging the template with at least two hard points of the component for positive location of the template relative to the component. Engaging the template can include sliding the template into place along a first hard point until meeting a second hard point that stops the template in position. At least one of the hard points can include at least one of a corner, hole, or stud of the component.

The method can further include forming the template using a solid model of the template, repeating engaging and marking until the template is worn down, and forming a replacement template using the solid model of the template. It is also contemplated that the method can include using the replacement template for engaging and marking until the replacement template is worn down. Forming the template and forming the replacement can include using the solid model to print the template and replacement template in an additive manufacturing process.

A template for locating position on a component includes a template body including mating features configured to engage corresponding hard points on a component, and a marking feature configured to locate a location on the component with the template body engaged with the hard points of the component. Each marking feature of the template can include a corner formed where at least two edges meet on the template. It is contemplated that the template body can include a plurality of marking features. It is also contemplated that the template body can be formed by an additive manufacturing process.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is an exploded perspective view of an exemplary embodiment of a template constructed in accordance with the present disclosure, schematically indicating the engagement of mating features of the template to hard points of the component;

FIG. 2 is a perspective view of the template of FIG. 1, showing the template engaged to the hard points of the component;

FIG. 3 is a perspective view of a portion of the template and component of FIG. 2, schematically indicating use of the marking features to mark the location for a gage on the component;

FIG. 4 is a plan view of another exemplary embodiment of a template constructed in accordance with the present disclosure, showing the marking features;

FIG. 5 is a perspective view of the template of FIG. 4, showing some of the marking features;

FIG. 6 is a perspective view of the template of FIG. 4, showing the mating features on the side opposite that shown in FIG. 5; and

FIG. 7 is a perspective view of a component corresponding to the template of FIG. 4, showing gage locations corresponding to the marking features of the template.

### DETAILED DESCRIPTION OF THE PREFERRED EMBODIMENTS

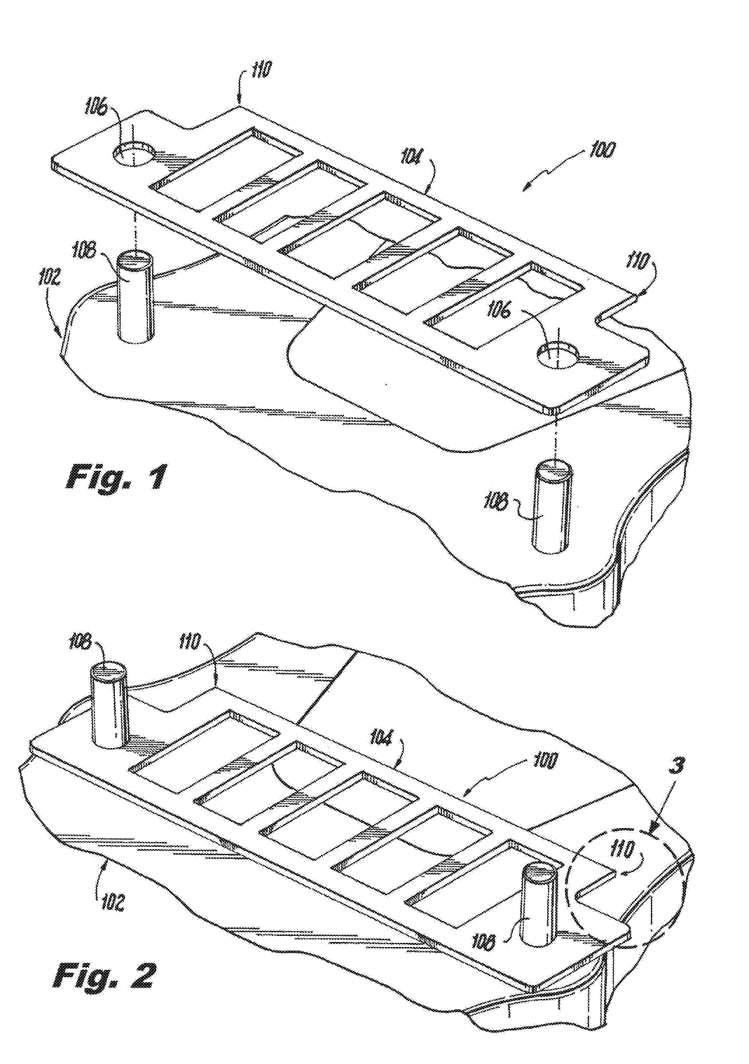

Reference will now be made to the drawings wherein like reference numerals identify similar structural features or aspects of the subject disclosure. For purposes of explanation and illustration, and not limitation, a partial view of an exemplary embodiment of a template in accordance with the disclosure is shown in FIG. 1 and is designated generally by reference character 100. Other embodiments of templates in accordance with the disclosure, or aspects thereof, are provided in FIGS. 2-7, as will be described. The systems and methods described herein can be used to facilitate locating positions on components, for example locating positions for gauges and/or flaws on components for use as specimens in testing such as endurance and fatigue testing in aerospace components.

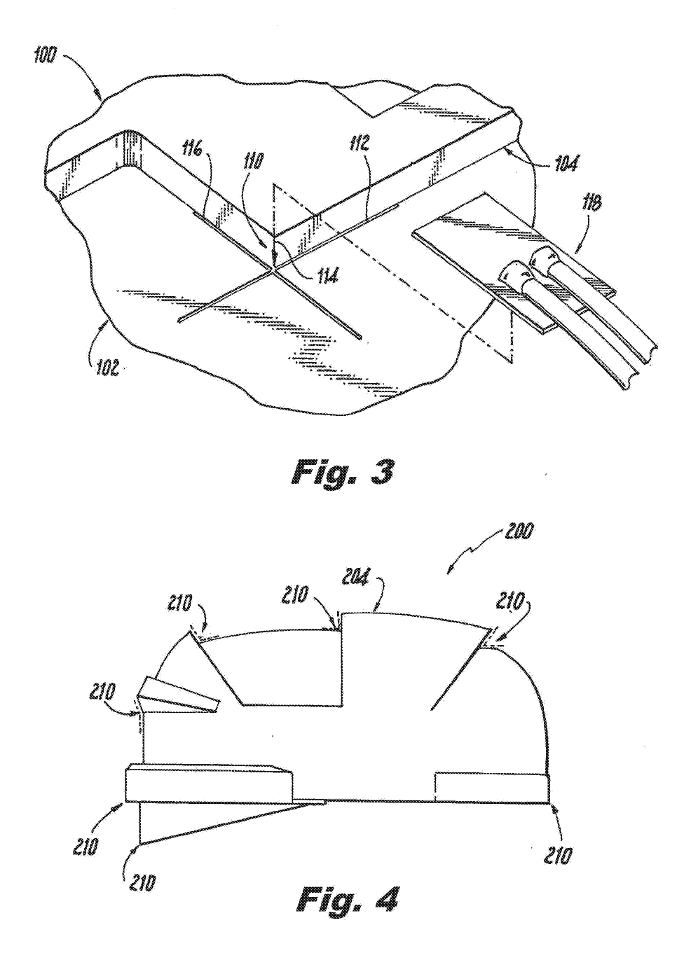

Template 100 for locating position on component 102 includes a template body 104 including mating features 106 that engage corresponding hard points 108 on component 102. The dashed lines in FIG. 1 indicate which mating feature 106 corresponds to which hard point 108 when template 100 is engaged to component 102 as shown in FIG. 2. Template 100 includes a pair of marking features 110, one of which is shown in detail in FIG. 3, each being configured to locate a specific location, indicated in FIG. 3 at the intersection of the two line segments, on component 102 with the template body 104 engaged with hard points 108 of component 102. It is contemplated that a template body in accordance with this disclosure can include any suitable number of marking features, including one or a plurality, as suitable for a given application. Each marking feature 110 of template 100 includes a corner formed where at least two edges meet on the template. In the example shown in FIG. 1, three edges 112, 114, and 116 meet at the corner of marking feature 110.

A method of locating position on a component, e.g., component 102, includes engaging a template, e.g., template 100, with the component and marking a location on the component using marking features, e.g., marking features 110, of the template. In the example shown in FIG. 3, the two edges 112 and 116 can be used to mark two line segments on component 102 that cross at an intersection point. The two resulting line segments follow the edges 112 and 116 of template 100, and this can be done at each respective corner corresponding to a marking feature 110, to mark the respective location on the component at the intersection of the two respective line segments. For example, marking each location can include marking a center point location for a strain gage 118 (which is shown in FIG. 3). The two respective intersecting line segments also provide the correct horizontal and vertical location and orientation for strain gage 118. Strain gage 118 is shown ready to be mounted in place in FIG. 3 for illustrative purposes, however it is to be understood that strain gage 118 is mounted after its center point location and orientation has been identified using the technique described above. This marking procedure can be followed for all of the marking features of template 100.

With reference again to FIG. 2, engaging template 100 with component 102 includes engaging template 100 with the two hard points 108 of component 102 for positive location of the marking features 110 of template 100 relative to the component 102, and therefore positive locations for the strain gages 118 on component 102. Those skilled in the art will readily appreciate that while in this example two hard points 108 are used for this purpose, in other applications any suitable number of mating features and hard points can be used as needed without departing from the scope of this disclosure, e.g., enough hard points to prevent the template from sliding, rotating, or otherwise moving position during the marking procedure. Hard points should be selected to facilitate consistent placement from specimen to specimen as a given template is used on different specimens of a given component. Engaging template 100 can include sliding template 100 into place along a first hard 108 point until meeting a second hard point that stops the template in position, e.g., template 100 slides along hard points 108 until it hits the base of component 102, which serves as a third hard point. In the example of FIG. 2, hard points 108 are studs. In the example of FIG. 7, the hard points 208 include holes in component 202. Those skilled in the art will readily appreciate that any type of hard point can be used for a given application, such as corners, holes, studs, or any other suitable type of hard point, without departing from the scope of this disclosure.

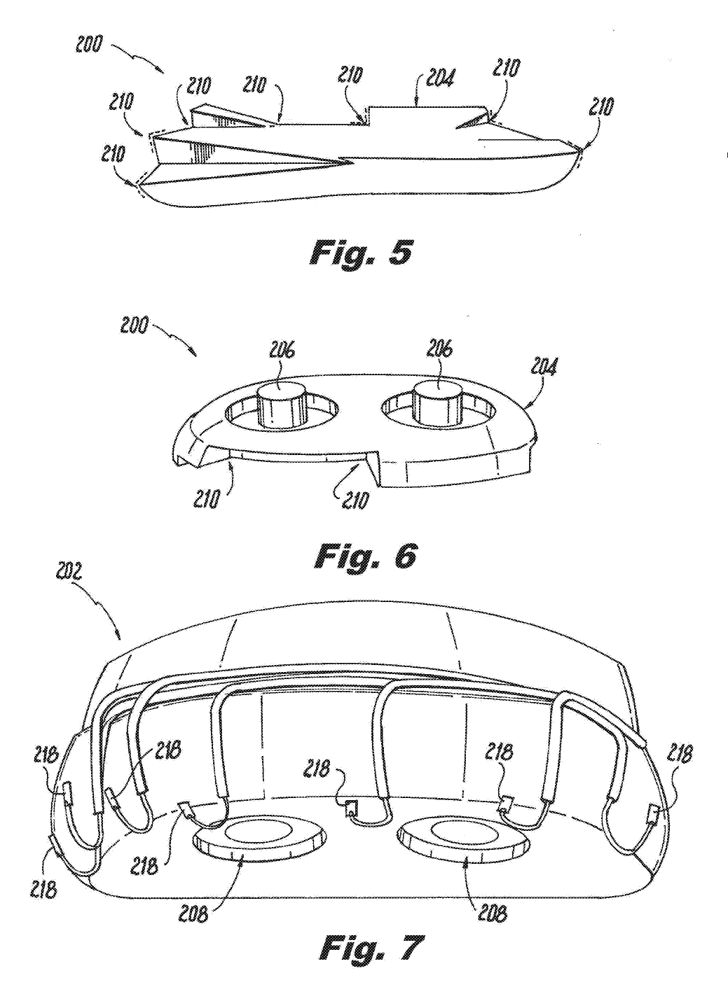

With reference now to FIG. 4, another exemplary embodiment of a template 200 having a template body 204 with seven marking features 210. It will be noted that three of the marking features 210 are exterior corners (e.g., where the solid material forms a 90° corner between the edges used for marking) and four of the marking features 210 are interior corners where the solid material forms a 270° corner between edges used for marking). The edges used for marking are indicated schematically with dashed lines in FIGS. 4 and 5. FIG. 5 shows a perspective view of the same side of template 200 as in FIG. 4, e.g., the top side as oriented in FIG. 5. FIG. 6, by comparison, shows the bottom side (as oriented in FIG. 5), which includes two mating features 206. Mating features 206 can engage hard points 208 of component 202, shown in FIG. 7 to position template 200 correctly to locate the positions and orientations for seven gages 218 in the same manner described above with respect to template 100. FIG. 7 shows the seven strain gages 218 mounted in position after using template 200 to mark the proper locations on component 202. It should be noted that the marking features 210 used to locate the center and orientation of strain gages 218 by drawing two intersecting line segments on component 202 are angled to provide the correct horizontal and vertical location and orientation of gages 218 which are on a filleted internal corner.

Templates 100 and 200 can be formed using a solid model of the template, as in a computer numerical controlled (CNC) type solid model. The procedures for engaging the template and marking the component can be repeated until the template is worn down. Using the same solid model, a replacement template can be formed. The replacement template can be used in the same manner until worn out, and it can in turn be replaced using the same solid model. For example, the templates as described herein can be formed using any suitable additive or subtractive manufacturing processes using the respective solid model. The additive or subtractive process should have tolerances within the acceptable tolerance for location of positions on the given component. For example, a template for placing strain gages on a component can be produced with an additive manufacturing process the tolerances of which are within the tolerance limit for the strain gage placement. Each replacement template can simply be printed, in an additive process for example. Since each replacement template is based on the same model, long term repeatability of locating gages on the respective component is facilitated.

While described herein in the exemplary context of placement of strain gages, those skilled in the art will readily appreciate that any other suitable type of gage or instrument can be placed on a component as described herein. For example, piezoelectric instruments, accelerometers, or the like could also be placed using the techniques described herein for component health monitoring purposes. It is also contemplated that flaws or other features such as stress risers can be placed in components in addition to or in lieu of placing gages without departing from the scope of this disclosure. The techniques described herein can be used for any suitable application requiring location of specific positions on components.

Potential advantages include reduced technician labor hours, reduction or elimination of rework due to misplaced gages and the like, and improved repeatability across multiple specimens. The methods and systems of the present disclosure, as described above and shown in the drawings, provide for locating positions on components with superior properties including improved facility, accuracy, and/or repeatability of location of positions on components relative to traditional techniques. While the apparatus and methods of the subject disclosure have been shown and described with reference to preferred embodiments, those skilled in the art will readily appreciate that changes and/or modifications may be made thereto without departing from the scope of the subject disclosure.

1. A method of locating position on a component comprising:
engaging a template with a component; and
marking a location on the component using marking features of the template.

2. The method as recited in claim 1, wherein marking a location includes marking a plurality of locations on the component using a plurality of respective marking features of the template.

3. The method as recited in claim 1, wherein each marking feature of the template includes a corner formed where at least two edges meet on the template.

4. The method as recited in claim 3, wherein marking each respective location on the component includes marking two line segments that cross at an intersection point, wherein the two line segments follow the edges of the template at each respective corner, to mark the respective location on the component at the intersection of the two respective line segments, and wherein the two line segments provide proper relative horizontal and vertical orientation.

5. The method as recited in claim 1, wherein marking each location includes marking a center point location for a strain gage.

6. The method as recited in claim 1, wherein engaging the template with the component includes engaging the template with at least two hard points of the component for positive location of the template relative to the component.

7. The method as recited in claim 1, wherein engaging the template includes sliding the template into place along a first hard point until meeting a second hard point that stops the template in position.

8. The method as recited in claim 1, wherein at least one of the hard points includes at least one of a corner, hole, or stud of the component.

9. The method as recited in claim 1, further comprising:
forming the template using a solid model of the template;
repeating engaging and marking until the template is worn down; and
forming a replacement template using the solid model of the template.

10. The method as recited in claim 9, further comprising:
using the replacement template for engaging and marking until the replacement template is worn down.

11. The method as recited in claim 9, wherein forming the template and forming the replacement includes using the solid model to print the template and replacement template in an additive manufacturing process.

12. The method as recited in claim 1, wherein marking a location includes marking a location for formation of a flaw in the component for testing purposes.

13. A template for locating position on a component comprising:
a template body including mating features configured to engage corresponding hard points on a component; and
a marking feature configured to locate a location on the component with the template body engaged with the hard points of the component.

14. The template as recited in claim 13, wherein each marking feature of the template includes a corner formed where at least two edges meet on the template.

15. The template as recited in claim 13, wherein the template body includes a plurality of marking features.
